(19) United States
(12) Patent Application Publication
(10) Pub. No.: US 2022/0030880 A1
(43) Pub. Date: Feb. 3, 2022

(54) BIO-PESTICIDE OIL FORMULATION

(71) Applicants: M/S Tricho Agronica Pvt. Ltd, Haryana (IN); Indian Oil Corporation Limited, Maharashtra- (IN)

(72) Inventors: Nidhi DIDWANIA, Haryana (IN); Sarita SACHDEVA, Haryana (IN); Alok SHARMA, Haryana (IN)

(21) Appl. No.: 17/290,629

(22) PCT Filed: Oct. 30, 2019
(86) PCT No.: PCT/IN2019/050794

§ 371 Date: Apr. 30, 2021

(30) Foreign Application Priority Data
Oct. 30, 2018 (IN) 201811041013

(51) Int. Cl. A01N 63/38; A01N 65/28; A01N 65/20; A01N 25/04; A01P 1/00

(52) U.S. Cl. CPC A01N 63/38; A01N 65/28; A01P 1/00; A01N 25/04; A01N 65/20

(57) ABSTRACT

“BIO-PESTICIDE OIL FORMULATION” The present invention relates to a bio-pesticide formulation and a process for the preparation thereof. Particularly this invention relates to a formulation useful against foliar plant diseases, wherein said bio-pesticide formulation comprises of: I.) a homogeneous component I comprising: Eucalyptus leaves; Trichoderma harzianum; and karanj cake, II.) a component II comprising: an agro oil in 50 to 80% of component II; water in 10 to 30% of component II; and one or more emulsifiers selected from the group consisting of glycerine, Tween 20 and propylene glycol in 02 to 30% of component II, III.) a carbon source in a percentage of 2 to 10%, and IV.) optionally a structural agent in a percentage of 2 to 10%.

### FIELD OF THE INVENTION

This present disclosure relates to a formulation and a process for the preparation thereof. In particular, the present disclosure relates to bio-pesticide formulation/composition for use in the agricultural fields, to save the crops from fungal and bacterial infections and a process of preparing the formulation.

### BACKGROUND OF THE INVENTION

Pesticides and/or fungicides are well known in the field of agriculture to save the crops from the damages caused by the fungal infections. Usually, the fungicides and/or pesticides that are used to save the crops from different kinds of fungal and bacterial infections are based on chemicals that have associated risk and hazards with their use. Some of the fungicides, bio-control agents & plant powders are also known by their company names, for examples, Koujikin, Green Harz, Hasiru, Biosar, Biocure (Trichoderma harzianum), Green field eco, Orchid eco (Plant powder).

IN 201711021416 discloses a bio-pesticide formulation and a process for the thereof.

The boi-pesticide formulation comprises 10-30% by weight fine powder of Antimicrobial plant, 5-20% by weight fine powder of a selected plant cake, 50-85% by weight fine powder of Trichoderma species strain, and a carrier in the ration of 1:8.5 with respect to Trichoderma species strain, 10-30% by weight fine powder of Antimicrobial plant is mixed with 5-20% by weight fine powder of a selected plant cake and 50-85% by weight fine powder of Trichoderma species strain. A carrier is then added in the above mixture in the ration of 1:8.5 with respect to Trichoderma species strain so as obtain fine powdered formulation and storing the same at room temperature for use as a bio-pesticide.

The fungicides/pesticides known in the art are associated with numerous disadvantages. One of the primary disadvantages is that excess and injudicious use of the conventional fungicides/pesticides imposes adverse effects on the environment and human health.

Another major disadvantage that is associated with use of conventional bio-control agents is that they have been found to be effective only against single phyto-pathogen.

Yet another disadvantage is that conventional fungicides/pesticides are not eco-friendly and therefore destroy ecological balance.

Still another disadvantage is that the conventional fungicides/pesticides create resistance, resurgence and residue problem.

Another disadvantage is that the conventional fungicides/pesticides are not effective against the major pathogens.

Another disadvantage is that the conventional fungicides/pesticides decreases plant vigor and reduces natural resistance of the agricultural land to fight against biotic and abiotic stresses.

In fact, not much work has been done to develop a bio-formulations using plant extracts and bio control agents in order to fight against plant pathogens. Therefore, there is a need in the art to develop/invent bio-formulations using plant extracts and bio control agents suitable for use in the agricultural fields to protect the crops from plant pathogens.

### OBJECTIVE OF THE INVENTION

The object of the present invention is to provide a bio-pesticide formulation/composition and a process for the preparation thereof which obviates the disadvantages associated with the formulation/composition known in the art.

Another object of the present invention is to provide a bio-pesticide formulation/composition, which can be used to reduce diseases in the crops and to increase the yield of crops.

Yet another object of the present invention is to provide a bio-pesticide formulation, the use of which does not impose adverse effects on the environment and human health.

Still another object of the present invention is to provide a bio-pesticide formulation/composition, which is effective against multiple phyto-pathogens.

A further object of the present invention is to provide a bio-pesticide formulation, which is eco-friendly and does not harm ecological balance.

Another object of the present invention is to provide a bio-pesticide formulation/composition, which does not have problems associated with resistance, resurgence and residue.

Yet another object of the present invention is to provide a bio-pesticide formulation, which is effective against all the major pathogens.

Still another object of the present invention is to provide a bio-pesticide formulation/composition, which does not decreases plant vigor and increases natural resistance of the agricultural land to fight against biotic and abiotic stresses.

### SUMMARY OF THE INVENTION

The present application provides a bio-pesticide formulation useful against foliar plant diseases, wherein said bio-pesticide formulation comprises of:

I. a homogeneous component I comprising:
i. an Eucalyptus leaves in 10 to 30 weight % of component I;
ii. a Trichoderma harzianum 50 to 85 weight % of component I; and
iii. a karanj cake in 05 to 20 weight % of component I,

II. a component II comprising:
i. an agro oil in 50 to 80% of component II;
ii. water in 10 to 30% of component II; and
iii. one or more emulsifiers selected from the group consisting of glycerine, Tween 20 and propylene glycol in 02 to 30% of component II,

III. a carbon source in a percentage of 2 to 10% , and

IV. optionally a structural agent in a percentage of 2 to 10%, and wherein homogeneous component I is in 2 to 25 weight % of the bio-pesticide formulation and component II is in 65 to 90 weight % of the bio-pesticide formulation.

In one of the aspect the bio-pesticide formulation comprises the homogeneous component I in 10 to 15 weight % of the formulation.

In another aspect the bio-pesticide formulation comprises glucose in 5 weight % of the formulation as the carbon source.

In another aspect the bio-pesticide formulation comprises the eucalyptus leaves of component I are from Eucalyptus obliqua.

In another aspect the bio-pesticide formulation comprises Tensiofix 869 in 5 weight % of the formulation as the structural agent.

In another aspect the bio-pesticide formulation comprises the component II comprising agro oil in 60 weight % the component II, water in 20 weight % the component II and an emulsifiers in 20 weight % the component II.

In another aspect the bio-pesticide formulation comprises the component II comprising agro oil in 70 weight % the component II, water in 20 weight % the component II and an emulsifiers in 10 weight % the component II.

In another aspect the present application provides a process for preparation of bio-pesticide formulation useful against foliar plant diseases, wherein said process comprises of:

(a) preparing component I comprising: powdered Eucalyptus leaves in 10 to 30 weight % of component I, powdered Trichoderma harzianum in 50 to 85 weight % of component I; and powdered karanj cake in 05 to 20 weight % of component I;

(b) preparing component II comprising 50 to 80% agro oil, 10 to 30% water, and 02 to 30% emulsifiers selected from the group consisting of glycerine, Tween 20 and propylene glycol;

(c) adding a component I in a percentage of 2 to 25% to component II;

(d) adding a carbon source in a percentage of 2 to 10% to suspension obtained in preceding step;

(e) optionally adding a structural agent in a percentage of 2 to 10% to component II; and

(f) homogenizing the suspension obtained in preceding step for 5 to 20 minutes at 3,000 to 8,000 rpm.

In another aspect the process for preparation of bio-pesticide formulation useful against foliar plant diseases comprises shade drying and grounding the Eucalyptus leaves to obtain fine powder of Eucalyptus leaves; incubating the Trichoderma harzianum in sorghum for 24 hours at a temperature of 28° C. and then collecting and grounding to obtain fine powder of Trichoderma harzianum; and grounding the karanj cake to obtain fine powder of karanj cake.

In another aspect the process for preparation of bio-pesticide formulation comprises adding component II comprising 60 to 70% agro oil, 20% water, and 10 to 20% emulsifiers.

In another aspect the process for preparation of bio-pesticide formulation comprises adding component I in a percentage of 10 to 15% to component II, adding the carbon source in 5 weight % of the formulation, adding the structural agent in 5 weight % the formulation, and homogenizing for 10 minutes at 5,000 rpm.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features of the process and the product referred to or indicated in this specification, individually or collectively and in any and all combinations of any or more of such steps or features.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described.

A bio-pesticide formulation/composition for use in the agricultural fields, to save the crops from fungal and bacterial infections and a process for the producing the bio-pesticide composition is described herein in detail along with examples.

The invention relates to an bio-pesticide formulation against foliar plant diseases comprising active ingredient selected from the group comprising a powdered combination of Trichoderma harzianum, eucalyptus leaves and karanj cake mixed with agro oil (B40035-H-70 LOBS GROUP 2) with one or more emulsifiers and optionally a structural agent for stability. The powdered combination of Trichoderma, eucalyptus leaves and karanj cake are disclosed in detail in Indian Patent application number 201711021416 and CROSS REFERENCE to disclosure of which is incorporated herein by reference herein in its entirety.

The oil-based formulations of a powdered combination of Trichoderma harzianum, eucalyptus leaves and karanj cake is found to effective in controlling the plant diseases because of their greater ability to adhere to the substrate and slowing down the desiccation process under conditions of fluctuating environmental factors such as temperature and relative humidity. Therefore, the study focused on assessing the feasibility of using oil dispersions as a carrier matrix. One of the surprising effect of the present disclosure is in having a prolonged shelf-life and persistence of the biological control agent on the biological target and thus improve the protection from foliar fungal diseases.

According to the process of the present invention the leaves of an antimicrobial plant, for example, Eucalyptus obliqua are collected and dried in shade. The dried leaves are then grounded to obtain fine powder thereof. Trichoderma strains are mass multiplied in a substrate or waste material, for example, sorghum, rice husk or starch received from the factories as a waste. The Trichoderma strains obtained after multiplication is incubated at a temperature of 28±2° C. for a period of about 168 hours. The incubated Trichoderma strains are then grounded to obtain fine powder thereof. Selected plant cake, for example, Karanj cake is grounded to obtain fine powder thereof. The agro oil (B40035-H-70 LOBS GROUP 2) with one or more organic emulsifiers, for example, glycerine, Tween 20 and propylene glycol and optionally a structural agent for example Tensiofix 869 is then mixed with homogenized combination powder of Trichoderma harzianum, eucalyptus leaves and karanj cake in the relative weight % of 50 to 85; 10 to 30; and 05 to 20, respectively. The bio-control agent comprises, for example, Trichoderma species strain. These ingredients are then mixed and homogenized together to obtain bio-pesticide composition. The bio-pesticide composition so obtained is stored at room temperature for use.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may vary.

### Example 1

Leaves of Eucalyptus obliqua plants are collected and dried in shade. The dried leaves are then grounded to obtain fine powder thereof. Trichoderma harzianum were mass multiplied in sorghum and were incubated at a temperature of 28° C. for a period of about 240 hours. The incubated Trichoderma strains are then grounded to obtain fine powder thereof. Karanj cake was grounded to obtain fine powder thereof. To develop the formulation, a mixture was prepared by first mixing the agro oil (B40035-H-70 LOBS GROUP 2) with the emulsifying-dispersing agent (glycerine and Tween 20) single and in combinations (60% agro oil +20% emulsifiers +20% water), and then adding 5% of the structural agent, 5% glucose as a carbon source and 10% of the combination powder of Trichoderma harzianum, eucalyptus leaves and karanj cake in the relative weight % of 50 to 85; 10 to 30; and 05 to 20, respectively. The mixture was homogenized for 10 minutes at 5,000 rpm. The bio-pesticide composition so obtained is stored at room temperature for use.

### Example 2

Leaves of Eucalyptus obliqua plants were collected and dried in shade. The dried leaves are then grounded to obtain fine powder thereof. Trichoderma harzianum were mass multiplied in sorghum and were incubated at a temperature of 28° C. for a period of about 240 hours. The incubated Trichoderma strains are then grounded to obtain fine powder thereof. Karanj cake was grounded to obtain fine powder thereof. To develop the formulation, a mixture was prepared by first mixing the agro oil (B40035-H-70 LOBS GROUP 2) with the emulsifying-dispersing agent (glycerine and Tween 20) single and in combinations (70% agro oil +10% emulsifiers +20% water), and then adding 5% of the structural agent, 5% glucose as a carbon source and 15% of the combination powder of Trichoderma harzianum, eucalyptus leaves and karanj cake in the relative weight % of 50 to 85; 10 to 30; and 05 to 20, respectively. The mixture was homogenized for 10 minutes at 5,000 rpm. The bio-pesticide composition so obtained is stored at room temperature for use.

Certain features of the invention have been described with reference to the example embodiments. However, the description is not intended to be construed in a limiting sense.

Various modifications of the example embodiments as well as other embodiments of the invention, which are apparent to the persons skilled in the art to which the invention pertains, are deemed to lie within the spirit and scope of the invention.

1. A bio-pesticide formulation useful against foliar plant diseases, wherein said bio-pesticide formulation comprises of:
I. a homogeneous component I comprising:
i. an Eucalyptus leaves in 10 to 30 weight % of component I;
ii. a Trichoderma harzianum in 50 to 85 weight % of component I; and
iii. a karanj cake in 05 to 20 weight % of component I,
II. a component II comprising:
i. an agro oil in 50 to 80% of component II;
ii. water in 10 to 30% of component II; and
iii. one or more emulsifiers selected from the group consisting of glycerine, Tween 20 and propylene glycol in 02 to 30% of component II,
III. a carbon source in a percentage of 2 to 10%, and
IV. optionally a structural agent in a percentage of 2 to 10%, and wherein homogeneous component I is in 2 to 25 weight % of the bio-pesticide formulation and component II is in 65 to 90 weight % of the bio-pesticide formulation.

2. The bio-pesticide formulation as claimed in claim 1, wherein the homogeneous component I is in 10 to 15 weight % of the formulation.

3. The bio-pesticide formulation as claimed in claim 1, wherein the eucalyptus leaves of component I are from Eucalyptus obliqua.

4. The bio-pesticide formulation as claimed in claim 1, wherein the carbon source is glucose and is in 5 weight % of the formulation.

5. The bio-pesticide formulation as claimed in claim 1, wherein the structural agent is Tensiofix 869 and is in 5 weight % of the formulation.

6. The bio-pesticide formulation as claimed in claim 1, wherein the component II comprises of: agro oil in 60 weight % the component II, water in 20 weight % the component II and an emulsifiers in 20 weight % the component II.

7. The bio-pesticide formulation as claimed in claim 1, wherein the component II comprises of: agro oil in 70 weight % the component II, water in 20 weight % the component II and an emulsifiers in 10 weight % the component II.

8. A process of preparation of bio-pesticide formulation useful against foliar plant diseases, wherein said process comprises of:
(a) preparing component I comprising: powdered Eucalyptus leaves in 10 to 30 weight % of component I, powdered Trichoderma harzianum in 50 to 85 weight % of component I; and powdered karanj cake in 05 to 20 weight % of component I;
(b) preparing component II comprising 50 to 80% agro oil, 10 to 30% water, and 02 to 30% emulsifiers selected from the group consisting of glycerine, Tween 20 and propylene glycol;
(c) adding a component I in a percentage of 2 to 25% to component II;
(d) adding a carbon source in a percentage of 2 to 10% to suspension obtained in preceding step;
(e) optionally adding a structural agent in a percentage of 2 to 10% to component II; and
(f) homogenizing the suspension obtained in preceding step for 5 to 20 minutes at 3,000 to 8,000 rpm.

9. The process as claimed in claim 8, wherein the Eucalyptus leaves are shade dried and grounded to obtain fine powder of Eucalyptus leaves; wherein the Trichoderma harzianum is incubated in sorghum for 24 hours at a temperature of 28° C. and then collected and grounded to obtain fine powder of Trichoderma harzianum; and wherein the karanj cake is grounded to obtain fine powder of karanj cake.

10. The process as claimed in claim 8, wherein the component II comprising 60 to 70% agro oil, 20% water, and 10 to 20% emulsifiers.

11. The process as claimed in claim 8, wherein the component I is added in a percentage of 10 to 15% to component II, wherein the carbon source is added in 5 weight % of the formulation, wherein the structural agent is added in 5 weight % the formulation, and wherein homogenization is carried out for 10 minutes at 5,000 rpm.
